(19) United States
(12) Patent Application Publication
(10) Pub. No.: US 2008/0060679 A1
(43) Pub. Date: Mar. 13, 2008

(54) Apparatus for cleaning a drainable Ostomy pouch and a method for cleaning a drainable Ostomy pouch

(76) Inventor: Paul Rosenberg, Scranton, PA (US)

Correspondence Address: James D. Cashel;Montgomery, McCracken, Walker & Rhoads, LLP, 123 S. Broad Street, Philadelphia, PA, 19109, US

(21) Appl. No.: 11/517,161

(22) Filed: Sep. 7, 2006

(51) Int. Cl. B08B 9/00

(52) U.S. Cl. 134/22.1

(57) ABSTRACT

There is disclosed a drainable ostomy pouch flusher which is easily inserted into a drainable pouch without spilling any of the flush water, and, a method for cleaning a drainable ostomy pouch which is less difficult, less time consuming, and which can be achieved with a high degree of cleanliness.

### CROSS-REFERENCE TO RELATED APPLICATIONS

Not applicable.

### FEDERALLY SPONSORED RESEARCH STATEMENT

Not applicable.

### THE NAMES OF THE PARTIES TO A JOINT RESEARCH AGREEMENT

Not applicable.

### REFERENCE TO MICROFICHE APPENDIX

Not applicable.

### BACKGROUND OF THE INVENTION

According to the International Ostomy Association, “[t]he word ostomy signifies a type of surgery required when a person has lost the normal function of the bladder or bowel due to birth defects, disease, injury or other disorders. Such operations include colostomy, ileostomy and urostomy. These operations allow for normal bodily wastes to be expelled through a new surgical opening (stoma) on the abdominal wall.”

According to the International Ostomy Association, an ostomate is a person who has had ostomy surgery.

As is well known, certain physical conditions require colostomy, ileostomy, urostomy and the like, wherein a pouch, called an ostomy pouch, is connected to the stoma for receiving body waste.

For ostomates, two types of pouching systems are available: drainable and closed-end.

Drainable pouches have a spout at the bottom of the pouch that is closed with a tail closure. To drain the pouch, the tail closure is removed and body waste is drained directly into a receiving device such as a toilet.

Closed-end pouches have no spout at the bottom and must be removed for disposal or emptying.

The collection of body waste in a drainable ostomy pouch, and the sanitary removal of the body waste, is often a difficult and time consuming procedure, at best, and not always achieved with a high degree of cleanliness.

Some of the common devices suggested to rinse a drainable pouch, such as a turkey baster, result in spillage and leakage.

As a result, many ostomates with drainable pouches have become frustrated and depressed with their inability to quickly and easily clean their drainable ostomy pouches, and feel as though they have lost control of their body.

### BRIEF SUMMARY OF THE INVENTION

It is an object of the present invention to provide a drainable ostomy pouch flusher apparatus which overcomes the above mentioned difficulties, and which is easily insertable into a drainable pouch without spilling any of the flush water.

It is another object of the present invention to provide a method for cleaning a drainable ostomy pouch which is a less difficult, less time consuming procedure, and which can be achieved with a high degree of cleanliness.

Other objects of the present invention will become apparent upon reading the following specification and referring to the accompanying drawings, which form a material part of this disclosure.

### BRIEF DESCRIPTION OF THE DRAWINGS

The invention will now be described by way of the drawings, in which:

FIG. 1 is a side view of the tip of the ostomy pouch flusher.

FIG. 2 is a side view of the tip of the ostomy pouch flusher.

FIG. 3 is a sectional view of the tip of the ostomy pouch flusher.

FIG. 4 is a sectional view of the tip of the ostomy pouch flusher and a side view of the squeeze bottle.

FIG. 5 is a view of the ostomy pouch flusher in the palm of an ostomate's hand.

FIG. 6 is a front view of a drainable ostomy pouch.

FIG. 7 is a front view of the ostomy pouch flusher in use by an ostomate.

FIG. 8 is a view of the ostomy pouch flusher in use.

FIG. 9 is a view of the ostomy pouch flusher in use.

### DETAILED DESCRIPTION OF THE INVENTION

An embodiment of the present invention consists of a squeeze bottle containing water to flush the drainable ostomy pouch, and a specially-designed curved tip for the bottle.

Drainable ostomy pouches have a spout at the bottom of the pouch that is closed with a tail closure.

To drain the pouch, the tail closure that keeps the pouch closed is removed.

Initially, the ostomate may desire to empty the bulk of the body waste in the pouch by squeezing out the contents of the pouch into a receiving device such as a toilet.

After emptying the bulk of the body waste from the drainable pouch, the ostomate may rinse out the pouch with room-temperature water.

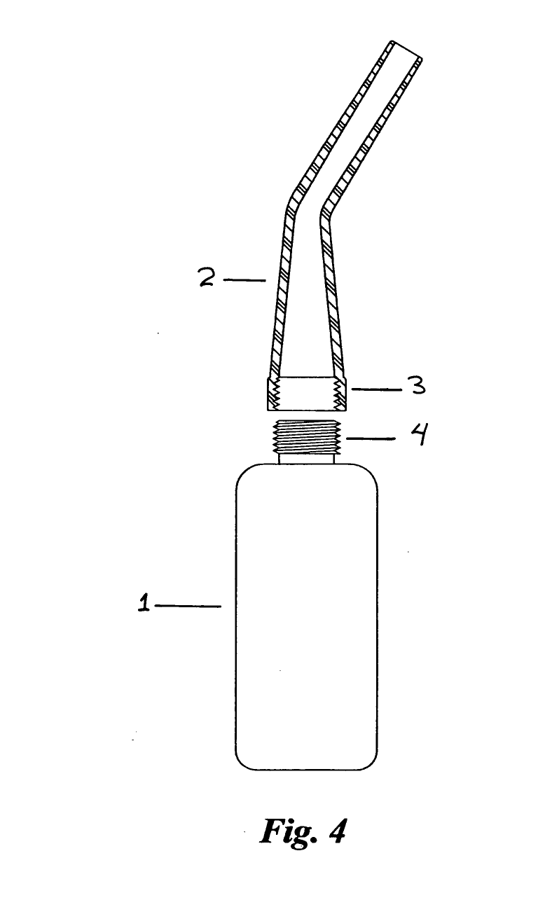

Referring now to FIG. 4, the ostomy pouch flusher consists of a squeeze bottle

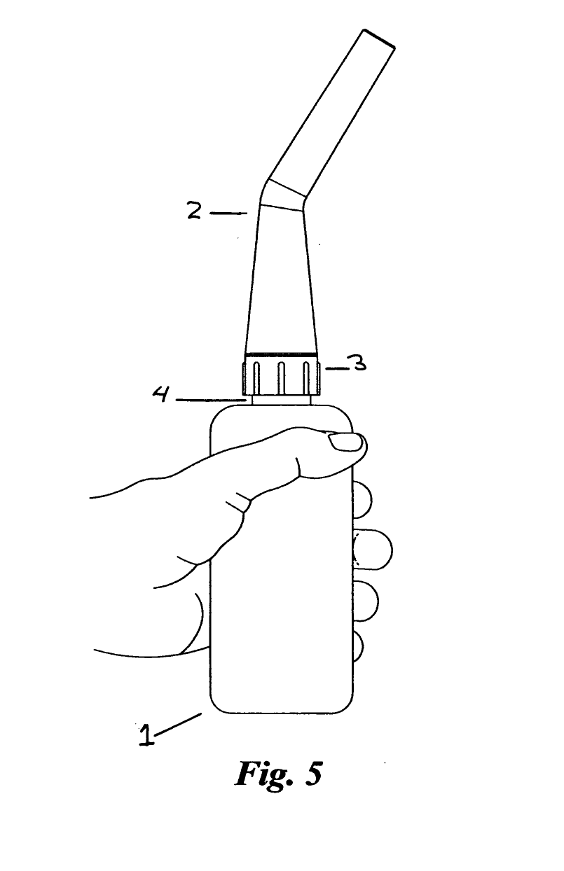

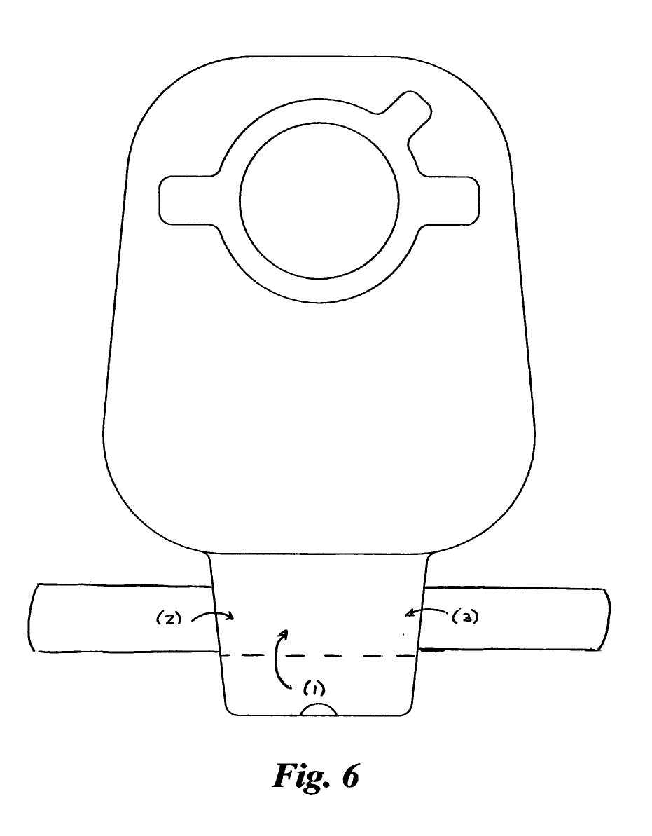

with a volume of approximately eight (8) ounces. The squeeze bottle [1] may be constructed from, for example, plastic or the like, and, referring to FIG. 5, should fit easily in the palm of the ostomate's hand.

Referring again to FIG. 4, the tip [2] of the squeeze bottle [1] may have a base [3]. The base [3] will have a width greater than the diameter of the mouth of the squeeze bottle [4].

As shown in FIG. 5, the base [3] of the tip [2] may be round in shape and fits securely to the mouth [4] of the squeeze bottle [1]. Of course, the base may be manufactured in a number of shapes and sizes and may fit securely to the squeeze bottle [1] in a number of ways.

Referring now to FIG. 4, in another embodiment of the present invention, the mouth [4] of the squeeze bottle [1] may be threaded with an outer diameter that is smaller than the inner diameter of the base [3] of the tip [2] such that the base can be attached to and removed from the mouth [4] of the squeeze bottle [1].

Referring to FIG. 3, the inner radius [5] of the tip [2] declines as you proceed from the base [3] to the discharge end [7] of the tip [2].

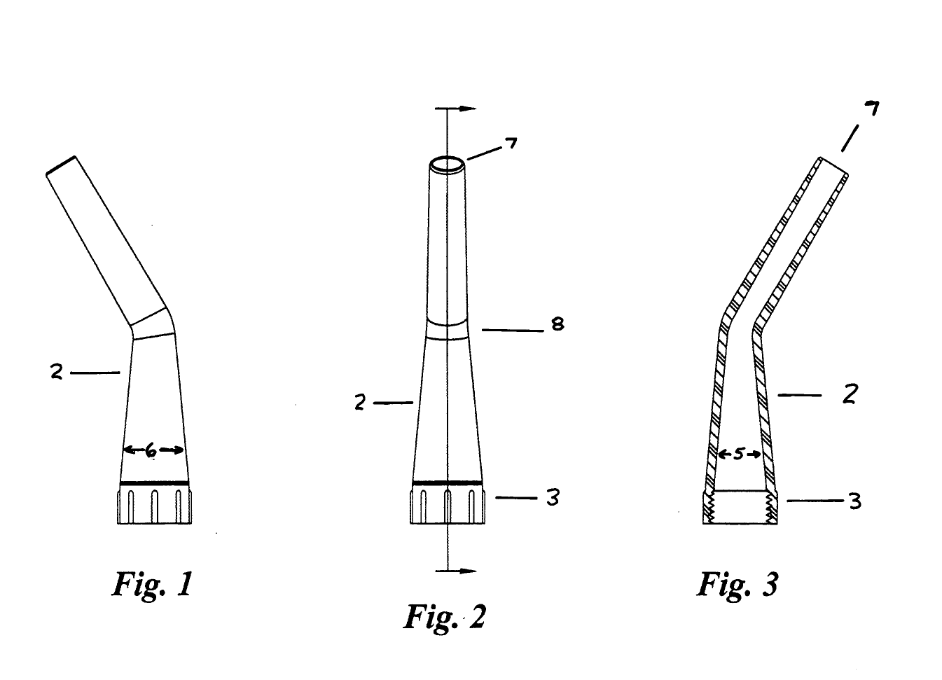

Referring to FIG. 1, the outer radius [6] of the tip [2] declines as you proceed from the base [3] to the discharge end [7] of the tip [2].

Referring to FIG. 2, at a point approximately equidistant between the base [3] and the discharge end [7] of the tip [2], there is an angular bend [8] in the tip [2] of approximately 30 degrees.

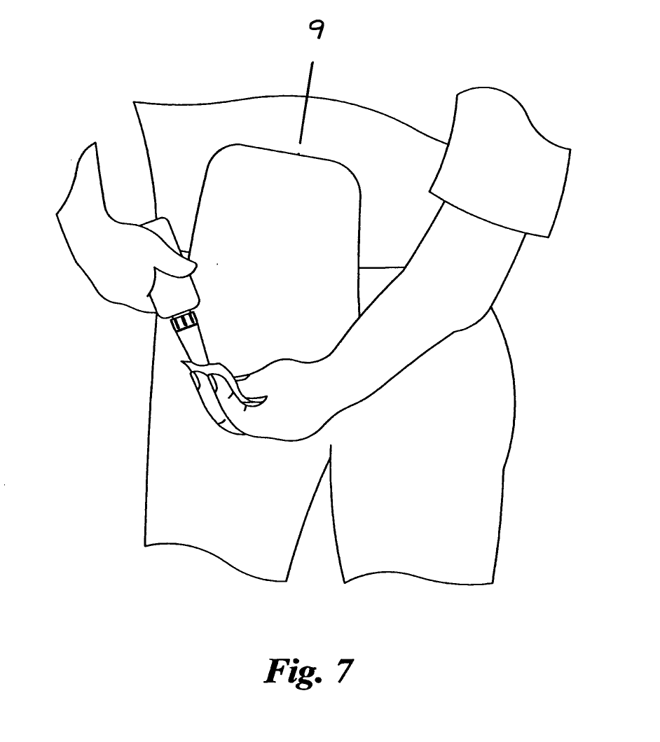

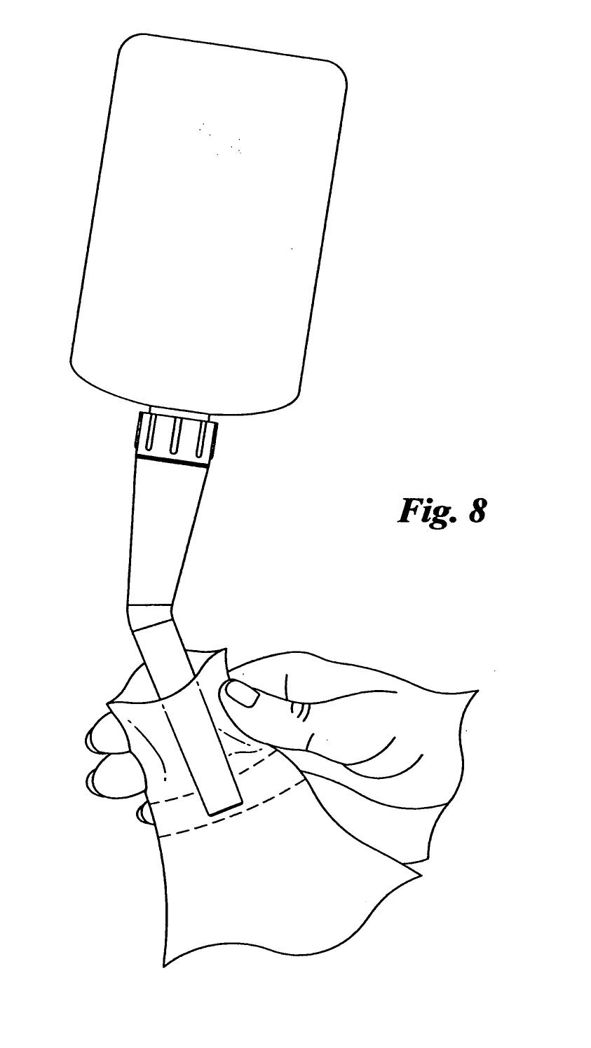

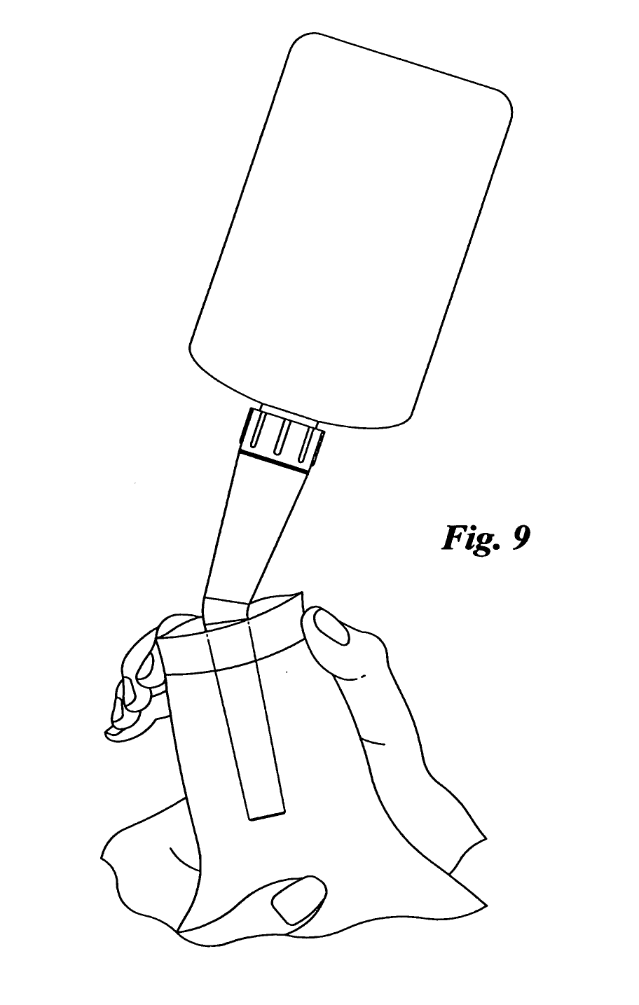

Referring to FIG. 7, the angular bend [8] in the tip [2] allows the squeeze bottle to be inserted into the drainable ostomy pouch [9] without any spillage of flush water outside of the drainable ostomy pouch. See also FIGS. 8 and 9. Of course, the angular bend [8] in the tip [2] may be in the range of one degree to ninety degrees, however, when the angular bend is closer to one degree there is an increased likelihood of spillage, and when the bend is closer to the closer to ninety degrees the ostomate needs to squeeze the bottle harder to discharge the flush water.

The method for cleaning a drainable ostomy pouch [9] with the ostomy pouch flusher consists of the following steps.

The spout [10] of the drainable ostomy pouch [9] is turned up and the tail closure [11] is removed by the ostomate.

Body waste in the pouch may be removed by squeezing out the contents of the pouch into a receiving device such as a toilet.

While the spout [10] of the drainable ostomy pouch [9] is turned up, the tip [2] of the ostomy pouch flusher is inserted into the open spout [10] of the drainable ostomy pouch [9].

After the tip [2] is inserted into the interior of the drainable ostomy pouch [9], the bottle [1] is squeezed by the ostomate's hand and the volume of flush water is discharged into the pouch [9].

The pouch [9] is then shaken slightly so that the waste in the pouch becomes entrained in the flush water.

Following the entrainment of the waste in the pouch in the flush water, the spout [10] of the pouch [9] is turned downward and the flush water is discharged into a receiving device such as a toilet or the like.

Following the discharge of the flush water, the tail closure is reinstalled on the spout by the ostomate.

From the forgoing it is seen that the device of the present invention provides a drainable ostomy pouch flusher which is simple in construction, capable of quick, easy and efficient flushing, and otherwise fully accomplishes its intended objects.

Although the present invention has been described in some detail by way of illustration and example for purposes of clarity of understanding, it is understood that certain changes and modifications may be made within the spirit of the invention.

What is claimed is:

1. A drainable ostomy pouch flusher, comprising
a. a squeezable bottle with a discharge end, and
b. an elongated tip with a base, an angular bend and a spout, wherein said base can be attached to said discharge end of said squeezable bottle for insertion into the spout of a drainable ostomy pouch.

2. The device of claim 1 wherein said squeezable bottle is constructed of plastic and has a volume of approximately eight ounces.

3. The device of claim 1 wherein the outer radius of said elongated tip declines as you proceed from said base to said spout.

4. The device of claim 1 wherein said elongated tip is approximately 5.25 inches in length.

5. The device of claim 1 wherein said angular bend in said elongated tip is between one (1) degree and eighty-nine (89) degrees.

6. The device of claim 1 wherein said angular bend in said elongated tip is approximately thirty (30) degrees.

7. A method for cleaning a drainable ostomy pouch, the method comprising the steps of:
a. filling the squeezable bottle with water;
b. attaching the base of the elongated tip to the discharge end of said squeezable bottle;
c. turning the spout of the drainable ostomy pouch upward while it remains attached to the ostomate's stoma;
d. removing the tail closure from said spout of said drainable ostomy pouch;
e. inserting the elongated tip into said spout of said drainable ostomy pouch;
f. squeezing said squeezable bottle in order to discharge said water into the interior of said drainable ostomy pouch;
g. shaking said drainable ostomy pouch so that the waste in said drainable ostomy pouch becomes entrained in said water;
h. turning the spout of the drainable ostomy pouch downward while it remains attached to the ostomate's stoma and discharging said water into a receiving device such as a toilet; and
i. reinstalling said tail closure onto said spout.
